(19) United States
(12) Patent Application Publication
(10) Pub. No.: US 2014/0377722 A1
(43) Pub. Date: Dec. 25, 2014

(54) SYNCHRONOUS PRESENTATION OF CONTENT WITH A BRAILLE TRANSLATION

(71) Applicant: Audible, Inc., Newark, NJ (US)

(72) Inventors: David W. Reid, Hoboken, NJ (US); Guy Ashley Story, New York, NY (US); Ajay Arora, New York, NY (US); Douglas Vincent O'Dell, Montclair, NJ (US); Douglas Cho Hwang, New York, NY (US)

(21) Appl. No.: 13/927,014

(22) Filed: Jun. 25, 2013

(51) Int. Cl. G09B 21/02

(52) U.S. Cl. CPC G09B 21/02
USPC 434/114

(57) ABSTRACT

A computing device may provide an interface that enables a user to synchronously present an item of primary content and a corresponding braille translation. The item of primary content may be an audio book, an e-book, or other form of media. The item of primary content may include supplemental information which may correspond, for example, to character descriptions, place descriptions, image descriptions, endnotes, footnotes, glossaries, appendices, commentary from an author, editor, or other party, or to additional supplemental information, and which may also have a corresponding braille translation. During presentation of the item of primary content, a user may indicate that an item of supplemental information associated with a current presentation position of the item of primary content should be presented. In some embodiments, this indication may be in response to an indication to the user that supplemental information is available. The device may then present the supplemental information associated with the current presentation position.

### BACKGROUND

Frequently, printed media are converted into audio format. Generally, this involves recording a narration or reading of the printed medium or text-to-speech translation. The resulting audio book or audio content may then be made available to users. Audio content may be presented or played back on a wide variety of devices, such as notebook and tablet computers, mobile phones, personal music players, electronic book (“eBook”) readers, and other devices with audio presentation capability.

Books and other literary media (whether in electronic or physical form) often contain a primary text and additional, supplemental information, such as character biographies, images, place descriptions, footnotes, end notes, glossaries and appendices. These items of supplemental information often contain useful or interesting information, such as additional background or explanatory text regarding the primary text, external references, or commentary. Such supplemental information may be presented in coordination with an electronic book or audio book.

However, it is difficult for visually impaired users to consume electronic books and textual or visual supplemental information. Accordingly, braille terminals with refreshable braille displays have been developed for use by visually impaired users. A braille terminal can be an electro-mechanical device that may be connected to a computing device, such as a laptop computer, desktop computer, table computer, etc. The braille terminal can display braille characters by means of the refreshable display, e.g., round-tipped pins raised through holes in a flat surface.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1A is a block diagram depicting an illustrative embodiment of a computing device in communication with a braille terminal;

FIG. 1B is a pictorial diagram depicting an illustrative embodiment of a braille terminal of FIG. 1A having a refreshable braille display;

FIG. 2 is block diagram depicting an illustrative operating environment in which the computing device of FIG. 1 may interact with an electronic marketplace to acquire an item of electronic content;

FIG. 3 is a flow diagram depicting an illustrative routine for synchronizing presentation of the item of electronic content with a presentation of a braille translation of the item of primary content on a braille terminal;

FIG. 4 is a flow diagram depicting an illustrative routine for presenting information that is supplemental to the item of primary content on a braille terminal; and

FIG. 5 is a flow diagram depicting an illustrative routine for notifying a user of a computing device and braille terminal that supplemental information is available.

### DETAILED DESCRIPTION

Generally described, aspects of the present disclosure relate to presentation of an item of primary content and of information supplemental to the item of primary content (herein, “supplemental information”) via a computing system equipped with a braille terminal or interface, or with other braille presentation capability. Specifically, systems and methods are disclosed for synchronizing presentation of an item of primary content with presentation of a braille translation of the item of primary content. In some embodiments, the item of primary content includes one or more items of supplemental information, such as footnotes, endnotes, glossary information, commentary, study guides, or the like. Accordingly, systems and methods are also disclosed for presenting supplemental information on a braille terminal in conjunction with the item of primary content. In some embodiments, the item of primary content (as well as the supplemental information) may include audio content. Thus, presentation of the item of primary audio content may be synchronized to presentation of a braille translation of the item of primary audio content on a braille terminal. In other embodiments, the item of primary content and/or the supplemental information may include textual or other visual content. Accordingly, presentation of the item of primary textual or other visual content may be synchronized to presentation of a braille translation of the item of primary textual or other visual content on a braille terminal. This may be useful, for example, when a sighted user wishes to use a braille terminal to learn how to read braille.

In one embodiment, a braille terminal with a refreshable braille display may be connected to a computing device, such as a laptop computer or electronic book reader, and a computing system including the computing device and the braille terminal may be used to obtain access to an item of primary content, such as an audio book. The item of primary content may then be translated into braille and instructions may be sent to the braille terminal for generating the braille translation on the refreshable braille display. The item of primary content and the braille translation may then be presented simultaneously to the user. For example, in the case of an audio book, the audio book may be output via one or more speakers of the computing device, while the braille translation of the audio book is synchronously output on the refreshable braille display of the braille terminal. In this manner, a visually impaired or other user may consume the braille translation of the audio book via touch while synchronously listening to the audio book. Systems and methods for synchronizing content of different types are disclosed in U.S. patent application Ser. No. 13/070,313, filed on Mar. 23, 2011 and entitled “SYSTEMS AND METHODS FOR SYNCHRONIZING DIGITAL CONTENT” (hereinafter, the “'313 application”), which is hereby incorporated by reference in its entirety.

The user may be able, in some embodiments, to control the speed of presentation of the item of primary content and/or braille translation in order to consume the braille translation at a comfortable pace. For instance, a user who is beginning to learn braille may elect to slow the output of an audio book, which will correspondingly slow the synchronized presentation of the accompanying braille translation on the braille terminal. Once the user has become more familiar with braille, the user may choose to speed up the presentation of the item of primary content and/or braille translation.

The item of primary content may include or be related to one or more items of supplemental information. Accordingly, in some embodiments, the supplemental information may also be presented to the user of the computing system while the user is consuming the item of primary content. For example, while the user is consuming an item of primary content such as an audio book and synchronously consuming the braille translation of the item of primary content on the braille terminal, the computing system may generate an indication that information supplemental to the recently presented primary content and/or braille content is available. The supplemental information may be accessed from one or more of a file containing instructions to generate a braille translation of the supplemental information on the refreshable display of the braille terminal, or a file containing audio or textual/visual information from which a braille translation of the supplemental information may be generated. Supplemental information may correspond to character biographies, place descriptions, footnotes, endnotes, glossaries, study guides, appendices, etc. Further, supplemental information may correspond to other information, such as author or editor commentary, or commentary from other users who have purchased the item of primary content. Still further, supplemental information may correspond to an auditory description of visual images accompanying the item of primary content. In some embodiments, a tactile representation of accompanying visual imagery may be available as supplemental information to be presented to the user on a suitably-configured braille terminal or interface. Systems and methods for managing presentation of supplemental information along with an item of primary content are disclosed in U.S. patent application Ser. No. 13/332,157, filed on Dec. 20, 2011 and entitled “MANAGING PLAYBACK OF SUPPLEMENTAL INFORMATION,” which is hereby incorporated by reference in its entirety.

In accordance with some embodiments, the computing system generates an indication that supplemental information is available at a predetermined time, such as at a time when the supplemental information is relevant to a current position of the item of primary content, or slightly before the supplemental information becomes relevant. In some embodiments, the indication may be auditory, such a chime, beep, or other tone emitted via a speaker of the computing device and/or braille terminal. In other embodiments, the indication may be haptic, such as a vibration or pattern of vibrations generated by the computing device and/or braille terminal. After receiving an indication that supplemental information is available, the user may enter a command indicating he or she wishes to access the supplemental information. In some embodiments, the command may be accepted if received during some period before and/or after the point at which the supplemental information is available (e.g., the user may be given n seconds during which a command can be entered). The command may be obtained at either the braille terminal or computing device by any input mechanism, such as the press of a button or key, or by voice command. After receiving the command, the computing system may then output the supplemental information to the user. In some embodiments, presentation of the item of primary content is interrupted or paused so that the supplemental information can be presented. The supplemental information may be audio content, textual or other visual content, or a braille translation of the foregoing types of content. Accordingly, when presentation of the item of primary content is paused, supplemental audio information may be output via a speaker of the computing device or braille terminal, supplemental textual or other visual information may be presented on a display of the computing device (e.g., in cases where the user is sighted and learning to read braille), or a braille translation of the supplemental information may be presented on the refreshable display of the braille terminal. In addition, presentation of the supplemental audio or textual information may be synchronized with presentation of a braille translation of the same on the braille terminal. After presenting the supplemental information, the computing device and braille terminal may return to the item of primary content at the position at which the user entered the command, or at a position near that at which the user entered the command. In some embodiments, the braille translation of the supplemental information may be presented on the braille terminal while the item of primary content continues to be presented by the computing device.

In one embodiment, the computing system may only indicate the availability of supplemental information that is of particular interest the user. Preventing generation of an indication for every item of supplemental information may be beneficial, for example, where the amount of supplemental information is large or where supplemental information is frequently available. Illustratively, a glossary or appendix of an item of primary content may be provided that contains explanatory information regarding characters, terms, locations, or entities within an item of primary content. The types of information within the glossary may be presented in braille on the braille terminal prior to presentation of the item of primary content and the user may elect preferred types of supplementary information for presentation. For example, in a story with many complex characters, the user may wish to be presented with character summaries at certain times, such as when a new character is introduced, or when a character is reintroduced after being absent from the story for a time.

In other embodiments, the computing system may not generate an indication that supplemental information is available. Instead, the user may indicate a desire for available information supplemental to recently presented primary content. Illustratively, if the item of primary content mentions a character name with which the user is not familiar, the user may input a command to search for supplemental information related to the character. The computing system may locate corresponding supplemental information associated with the character. The corresponding supplemental information may then be presented as described above. In this manner, a user consuming a braille translation of the item of primary content may be provided with access to the same supplemental information available to a typical user. In these embodiments, another indication or notification may be generated by the computing system if no supplemental information associated with the item of primary content can be found.

When presentation of an item of supplemental information has concluded, presentation of the item of primary content may continue from a point at or near the point where the user issued the command to present the supplemental information. Illustratively, presentation may resume at the exact point the command was received, or at some fixed time period prior to or following that point (e.g., 3 or 5 seconds). Presentation may also resume at a point determined based at least in part on the braille translation of the item of primary content. For example, in the case of an audio book, presentation may resume at the point in the audio book just prior to the sentence in which the user entered a command to obtain supplemental information. In other embodiments, presentation may resume at the beginning of a paragraph, a word, or other unit of text or narration. In these embodiments, an indicator of supplemental information may be suppressed for supplemental information that has already been presented. In embodiments that synchronously present the item of primary content and the braille translation thereof, synchronization data for the braille translation and the item of primary content may be used to resume presentation of the item of primary content after supplemental information is presented. Systems and methods for generating such synchronization data are disclosed in the '313 application previously incorporated herein by reference.

In some embodiments, an item of supplemental information may be associated with multiple positions within an item of primary content. For example, supplemental information may be associated with a position within a chapter of an item of primary content, and also associated with the end of that chapter. In this manner, a user may have multiple opportunities to be presented with an item of supplemental information. Further, an item of supplemental information may be associated with a position within another item of supplemental information. For example, a first item of supplemental information, such as a first character summary, may be associated with a position in an item of primary content, and a second item of supplemental information, such as a second character summary where the second character is related to the first character, may be associated with a position in the first item of supplemental information. The second item of supplemental information may itself have one or more additional items of supplemental information associated with it. As such, multiple levels of supplemental information may be provided, each new level associated with a previous level or the item of primary content. In embodiments where associations of supplemental information would cause the supplemental information to be available multiple times within the presentation of the item of primary content, indication of the availability of that supplemental information may be suppressed after the first indication that the supplemental information is available. In other embodiments, indication of supplemental information may be suppressed after the supplemental information has been fully presented.

In some embodiments, items of primary content and supplemental information may be stored within data storage of the computing system. In other embodiments, items of primary content and/or supplemental information may be stored remotely from the computing system, such as on a remote server or in a remote data store or data storage web service. Illustratively, the computing system may be configured to retrieve the remotely stored items of primary content and/or supplemental information. In some embodiments, supplemental information associated with an item of primary content may be retrieved at substantially the same time as the item of primary content. In other embodiments, the computing system may be configured to retrieve supplemental information periodically. For example, the computing system may query a remote server every n hours in order to determine whether new supplemental information is available. In further embodiments, the computing system may query a remote server for supplemental information associated with an item of primary content currently being presented. In still other embodiments, a remote server may be configured to notify the computing system of available supplemental information.

Similarly, in some embodiments, braille translations of items of primary content and supplemental information may be generated by the computing system and stored within data storage of the same. Some or all of the braille translations generated by the computing system may be made available to other users, for example, by sharing via a network. In other embodiments, braille translations of items of primary content and/or supplemental information may be generated and stored remotely from the computing system, such as on a remote server or in a remote data store or data storage web service. The braille translations of items of primary content and/or supplemental information may be remotely stored in association with the corresponding supplemental information and/or items of primary content. When the computing system queries the remote server for an item of primary content and/or supplemental information, the server may be configured to check whether a braille terminal is connected to or incorporated into the computing device, and if so, then to send any available braille translations corresponding to the queried item of primary content and/or supplemental information. In some embodiments, the computing system may send a separate query for available braille translations corresponding to queried items of primary content and/or supplemental information. The computing system may receive braille translations of some portions of the item of primary content and/or supplemental information, and may generate braille translations for other portions.

In some embodiments, a user of the computing system may specify types of supplemental information which are desired. For example, a user may specify that supplemental information associated with the author (e.g., footnotes, glossaries, author commentary, etc.) should be presented, while supplemental information associated with the publisher (e.g., editor commentary, etc.) should not be presented. Further, a user may specify that supplemental information associated with contacts of the user should be presented, while supplemental information associated with general users of an electronic marketplace from which the item of primary content was acquired should not be presented.

In further embodiments, a user of the computing system may specify categories of supplemental information which are desired. For example, where an item of primary content has been acquired from an electronic marketplace, the electronic marketplace may categorize items of supplemental information related to the item of primary content into one or more categories. Examples of such categories include, but are not limited to, “Top Rated,” “Funny,” “Insightful,” “Informative,” and “Interesting.” Illustratively, a user may specify that only supplemental information listed as “Top Rated” or “Funny” should be obtained and presented, while other supplemental information should be excluded. In some embodiments, where a user has excluded some types of supplemental information and where that supplemental information is stored remotely from the computing device, it may not be necessary for the computing device to retrieve the remotely stored supplemental information.

In addition, an item of primary content or supplemental information can refer to any data containing visual, audio, or tactile information that can be directly or indirectly accessed by a user, including, but not limited to, multi-media data, digital video, audio data, electronic books (“eBooks”), electronic documents, electronic publications, computer-executable code, portions of the above, and the like. References to textual content or other visually displayed content should be understood to include any form of visual or tactile content, including text, images, charts, graphs, slides, maps, braille, embossed images, or any other content capable of being displayed in a visual or tactile medium. Items of primary content or supplemental information may be stored on a computing device, may be generated by the computing device, or may be streamed across a network for display or output on the computing device. Moreover, content may be obtained from any of a number of sources, including a network content provider, a local data store, computer readable media, a content generation algorithm (e.g., a text-to-speech algorithm) running remotely or locally, or through user input (e.g., text entered by a user). Content may be obtained, stored, or delivered from any one or combination of sources as described above.

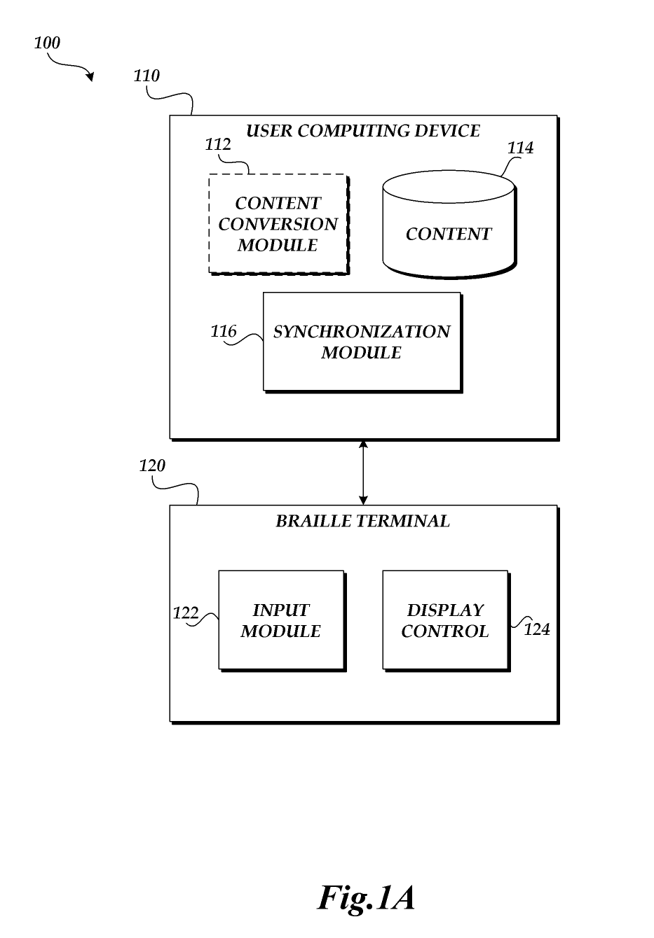

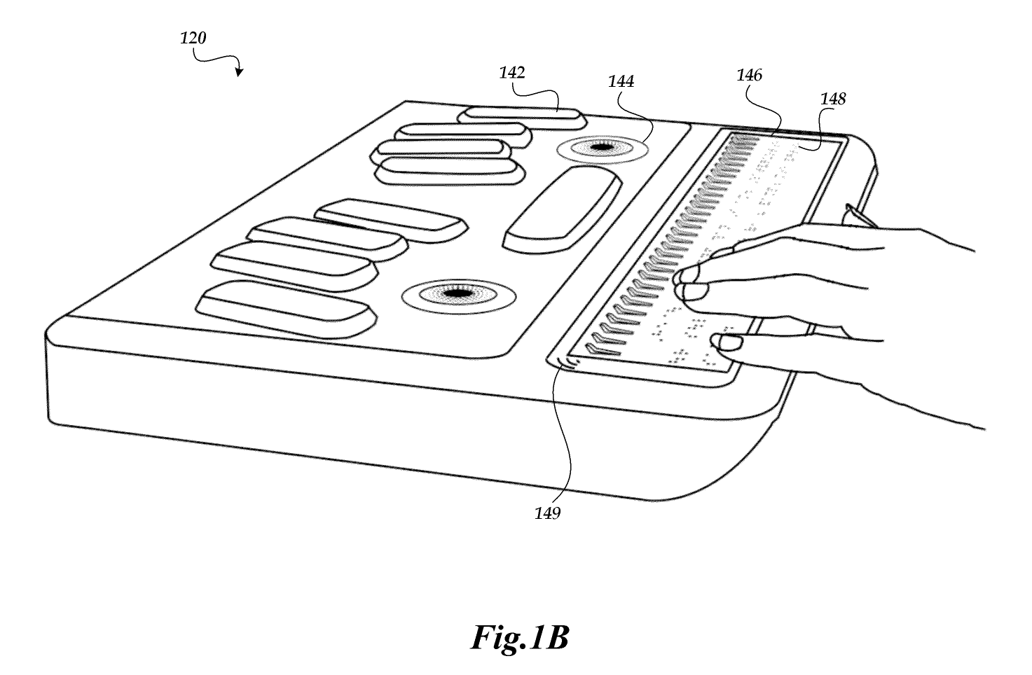

FIG. 1A illustrates one embodiment of a computing system 100 including a computing device 110 which is configured to communicate content with a braille terminal 120 having a refreshable braille display. The computing device 110 may include a content data store 114, a synchronization module 116, and optionally a content conversion module 112. The braille terminal 120 having the refreshable braille display may include an input module 122 and a display control module 124. While FIG. 1A depicts the braille terminal 120 as externally connected to the computing device, those skilled in the art will recognize that the braille terminal 120 may be incorporated into the computing device with departing from the scope of the present disclosure.

The computing device 110 may be any personal computing device capable of presenting items of primary content and supplemental information to a user. For example, computing device 110 may be a laptop, personal computer, a tablet computer, personal digital assistant (PDA), hybrid PDA/mobile phone, mobile phone, electronic book reader, digital media player, appliance, electronic device for inclusion in vehicles or machinery, gaming device, set top box, electronic device for inclusion in televisions, smart watch, and the like. The computing device 110 may include any of a number of visual, tactile, or auditory output devices. For example, computing device 110 may include, connect to, or control one or more of an LCD or LED screen, projection device, speakers, headphone jack, vibratory motor, piezoelectric display, and the like. Computing device 110 may be associated with a number of devices for user input, including, but not limited to, buttons, keyboards, mice, trackballs, trackpads, joysticks, input tablets, trackpoints, touch screens, remote controls, game controllers, motion detectors and the like.

Computing device 110 may also be associated with the braille terminal 120 having the refreshable braille display. In some embodiments, the computing device 110 and braille terminal 120 may be separate devices, and may be connectable, for example via a cable or a wireless connection. In other embodiments, the computing device 110 and braille terminal 120 may be an integrated device, such as a braille computer, laptop, notepad, tablet, or smartphone.

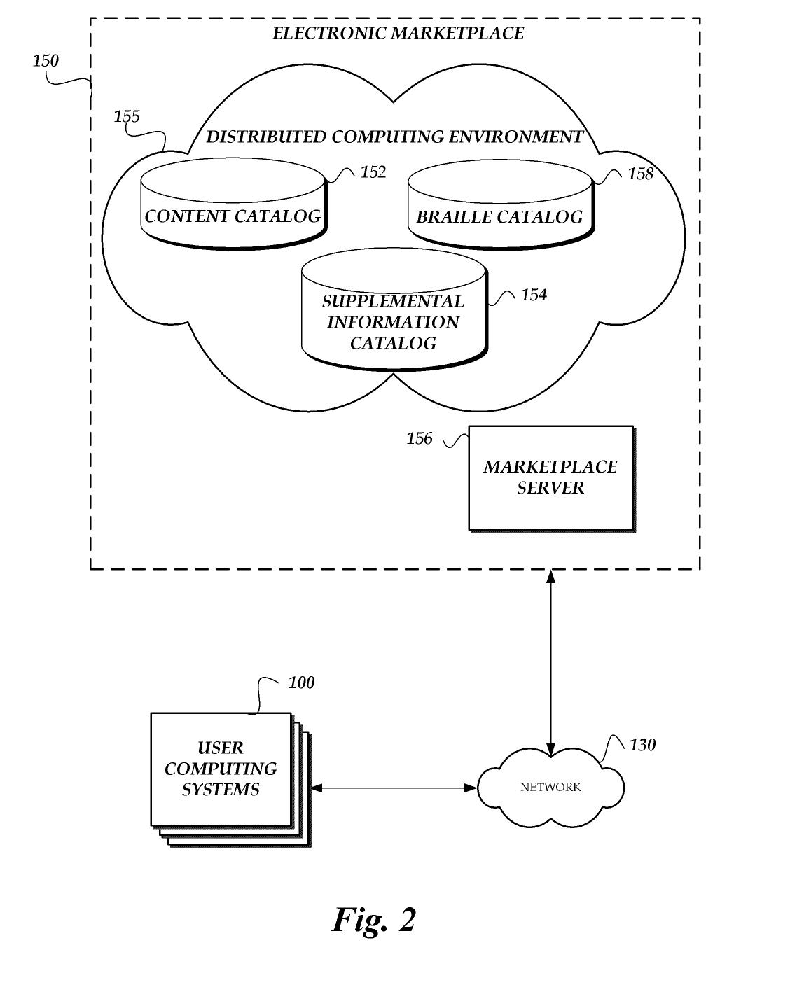

In the illustrated embodiment, the computing device 110 includes a content data store 114. Content data store 114 may include non-transitory data storage media integrated into the computing device 110 such as a hard disk drive or solid state drive. Content data store 114 may further include random-access memory (RAM). In other embodiments, the content data store 114 may be part of a remote device, such as a server, and may be accessed via a network as will be discussed more with respect to FIG. 2. The content data store 114 may be configured to store items of primary content such as electronic books and/or audio books. In some embodiments the content data store 114 may also store a braille translation of an item of primary content and/or synchronization data used for simultaneous or synchronous presentation of an item of primary content and a braille translation of the same.

However, in other embodiments no braille translation may be readily available for an item of primary content. Therefore, computing device 110 may in some embodiments further include content conversion module 112 for generating braille translations of items of primary content. For example, content conversion module 112 may perform a text-to-braille conversion for an item of primary content such as a text file or electronic book. In the case of an item of primary content such as an audio file or audio book, the content conversion module 112 may be configured to locate a corresponding text file, for example an electronic book version of an audio book, and perform a text-to-braille conversion to obtain the braille translation of the audio book. In another embodiment, the content conversion module 112 may be configured with speech recognition capabilities, and may generate the braille translation directly from the audio file or audio book. In yet other embodiments, the content conversion module 112 may be configured to search a data store for a braille translation of an item of primary content. The content conversion module 112 may also be configured with any combination of the previously described capabilities.

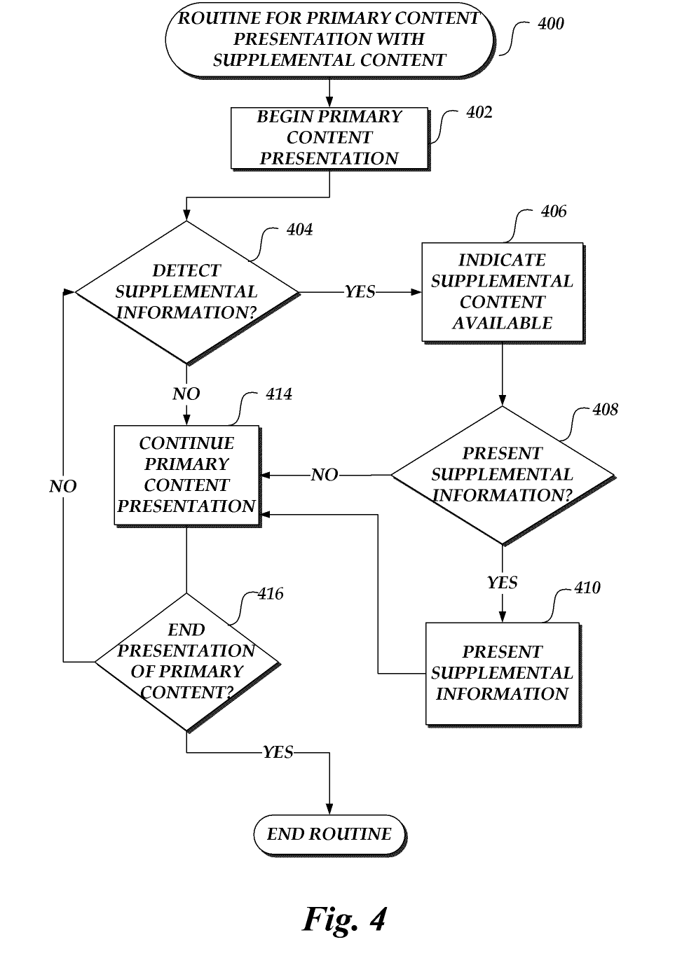

The computing device 110 may also include synchronization module 116. The synchronization module 116 may be configured to monitor a presentation position of the item of primary content and to update the presentation position as the item of primary content is presented. Synchronization module 116 may further be configured to monitor a presentation position of a braille translation and to use synchronization data to present the braille translation synchronously, or in a generally coordinated manner, with the corresponding item of primary content. Further, synchronization module 116 may be configured to store a current presentation position of both the item of primary content and the corresponding braille translation in the event of pausing synchronized presentation, for example in order to present supplemental information, as will be discussed in more detail with respect to FIG. 4. The synchronization module 116 may also handle coordinated presentation of the item of primary content together with supplemental information, or of supplemental information together with a corresponding braille translation of the supplemental information. The synchronization module 116 may also handle user requests for speed changes, such as slowing down the presentation of the braille translation, by also slowing down presentation of the corresponding item of primary content. Further, the synchronization module 116 may maintain a coordinated presentation of an item of primary content and the corresponding braille translation when a user fast forwards, rewinds, or selects a new position within either of the item of primary content or the braille translation.

It will be understood that synchronous presentation of an item of primary content and a corresponding braille translation does not require perfectly synchronized presentations. That is, synchronous presentation does not require each letter, word, sentence, or page of an item of primary textual content and each letter, word, sentence or page of the corresponding braille translation be presented simultaneously, nor does it require simultaneous presentation or utterance of each sound or word in an item of primary audio content with the corresponding braille letter or word. For example, the size of the refreshable braille display may determine how many different braille letters or words may be presented at once, and the braille translation may be presented in segments corresponding to the size of the refreshable braille display. Some refreshable braille displays may be sized to present a single braille letter at a time, some may be sized to present multiple letters at a time, and some may be sized to present a large set of braille text at once, such as a sentence or paragraph. The braille translation segments presented on the display may contain fewer braille letters than the available display size in order to present only whole words.

To illustrate, in one embodiment the synchronization module 116 may determine that a portion of primary content to be presented is larger than the available display size of the refreshable braille display of the braille terminal 120. Thus, the synchronization module 116 may cause the braille display to refresh one or more times during presentation of the corresponding portion of the primary content. In another embodiment, the synchronization module 116 may determine the number of words in a portion of primary content to be synchronously presented. When the first word in the portion of primary content is presented, the synchronization module 116 may cause the refreshable braille display to present all of the words in that portion of primary content. A user may follow along on the refreshable braille display as the corresponding portion of primary content is presented. The synchronization module 116 may then determine how many words in a next portion of the primary content will fit on the refreshable braille display, and after the last word in the prior portion of primary content portion is presented of the refreshable braille display, the synchronization module 116 may update the refreshable braille display with the braille translation corresponding to the next portion of primary content.

As shown in FIG. 1A, the braille terminal 120 with refreshable braille display includes an input module 122 and a display control module 124. The input module 122 may be in communication with the synchronization module 116 of the user computing device 110. Using an input interface on the braille terminal 120, a user may signal or command the braille terminal 120 to pause, increase or decrease speed, change positions within the content or braille translation, increase or decrease volume, begin presentation of supplemental information, or the like. These commands may be communicated to the synchronization module 116 which may alter presentation of the item of primary content accordingly.

The braille terminal 120 may also include display control module 124, which manages output of braille letters or characters on the refreshable braille display of the braille terminal 120. Display control module 124 may store the braille translation and present portions of the translation that fit on the refreshable braille display, or may be sent such portions by the user computing device 110. In some embodiments, the display control module 124 may operate together with the synchronization module 116 to determine the portion of content which will fit on the refreshable braille display.

Turning to FIG. 1B, one embodiment of the braille terminal 120 with refreshable braille display of FIG. 1A is illustrated in more detail. The braille terminal 120 may include a plurality of input keys 142, speakers 144, a refreshable braille display portion 146 containing presented braille 148, and an alert portion 149.

The braille terminal 120 of FIG. 1B is illustrated as an electro-mechanical device, in which the refreshable braille display portion 146 may employ a plurality of movable, round-tipped pins and actuators in order to present the required tactile dots for presented braille. The pins may be raised and lowered in response to an electric signal. However, it will be understood that the depicted embodiment is meant to illustrate and not to limit the types of braille terminals compatible with the present disclosure. In some embodiments, the refreshable braille display portion 146 may include a piezoelectric layer which creates vibrations in braille patterns, and the piezoelectric layer may be used with a touch screen that is part of a computing device such as a laptop, tablet, smart phone, handheld gaming console, etc. In another embodiment, the refreshable braille display portion 146 may include a surface material which may dynamically change shape in order to present braille, such as in response to the electric currents, magnetic fields, or electromagnetic signals. Such dynamically shapeable surfaces may be able to present three-dimensional representations of objects in addition to rendering braille. Further embodiments may present braille to the user by means of a glove having vibration motors located to generate vibrations felt by different portions of the hand.

Returning to FIG. 1B, the plurality of input keys 142 of the braille terminal 120 may be used for typing in braille or for sending commands or control functions to the braille terminal 120 and/or user computing device 110. The braille terminal 120 may also include other input devices, for example wheels for scrolling through braille text, a microphone for dictation or voice commands, and ports for connection to other devices. The speakers 144 may be used to present audio content, for example items of primary audio content presented synchronously with corresponding braille text. The alert portion 149 may be used to present the user with an indication that supplemental information is available for the currently presented item of primary content and/or braille. The alert portion 149 may present a sound such as a beep and/or may present a tactile indication such as a vibration.

The refreshable braille display portion 146 is depicted as a flat panel including a plurality of cells, each cell capable of presenting three rows of braille letters or characters. However, each cell may also be configured to present more or fewer rows of braille letters. Further, some embodiments the braille display portion 146 may also take the form of a rotatable wheel for continuous presentation of refreshable braille, wherein the cells may be rotated under a reader's fingertips to present a continuous stream of braille. The braille display portion 146 is used to present the braille 148 and may be controlled by the display control module 124 illustrated in FIG. 1.

FIG. 2 is a schematic block diagrams depicting an illustrative operating environment in which a computing system 100 of FIGS. 1A-B may interact with an electronic marketplace 150 to acquire items of primary content and supplemental information. As illustrated in FIG. 2, the operating environment includes one or more user computing devices 100, such as the computing device of FIG. 1A, in communication with the electronic marketplace 150 via a network 130.

Those skilled in the art will appreciate that the network 130 may be any wired network, wireless network or combination thereof. In addition, the network 130 may be a personal area network, local area network, wide area network, cable network, satellite network, cellular telephone network, or combination thereof. In the illustrated embodiment, the network 130 is the Internet. Protocols and components for communicating via the Internet or any of the other aforementioned types of communication networks are well known to those skilled in the art of computer communications and thus, need not be described in more detail herein.

A user, using his or her user computing system 100, may communicate with the electronic marketplace 150 to acquire items of primary content. Braille translations and/or supplemental information corresponding or related to items of primary content may also be made available by the electronic marketplace 150. In one embodiment, a user, utilizing his or her computing system 100 may browse descriptions of items of primary content made available by the electronic marketplace 150. In another embodiment, a user, utilizing his or her computing system 100 may acquire a desired item of primary content, together with supplemental information regarding the item of primary content and corresponding braille translation, as well as synchronization data, from the electronic marketplace 150. Braille translations available in the electronic marketplace 150 may have been generated by other users of the electronic marketplace 150 and then shared. In some embodiments only the item of primary content and supplemental information may be available in the marketplace 150, and the user computing system 100 may generate a braille translation for the item of primary content and supplemental information, as well as synchronization data. In further embodiments, the computing system 100 may share generated braille translations and/or synchronization data with other computing devices via a network, such as by sending the braille translation to another computing device and/or making the braille translations accessible by other users of the electronic marketplace 150.

The electronic marketplace 150 is illustrated in FIG. 2 as operating in a distributed computing environment including several computer systems that are interconnected using one or more networks. More specifically, the electronic marketplace 150 may include a marketplace server 156, a content catalog 152, a supplemental information catalog 154, a braille catalog 158, and a distributed computing environment 155 discussed in greater detail below. However, it may be appreciated by those skilled in the art that the electronic marketplace 150 may have fewer or greater components than are illustrated in FIG. 2. In addition, the electronic marketplace 150 could include various web services and/or peer-to-peer network configurations. Thus, the depiction of electronic marketplace 150 in FIG. 2 should be taken as illustrative and not limiting to the present disclosure.

Any one or more of the marketplace server 156, the content catalog 152, the supplemental information catalog 154, and the braille catalog 158 may be embodied in a plurality of components, each executing an instance of the respective marketplace server 156, content catalog 152, supplemental information catalog 154, and braille catalog 158. A server or other computing component implementing any one of the marketplace server 156, the content catalog 152, the supplemental information catalog 154, and braille catalog 158 may include a network interface, memory, processing unit, and computer readable medium drive, all of which may communicate which each other may way of a communication bus. The network interface may provide connectivity over the network 130 and/or other networks or computer systems. The processing unit may communicate to and from memory containing program instructions that the processing unit executes in order to operate the respective marketplace server 156, content catalog 152, supplemental information catalog 154, and braille catalog 158. The memory may generally include RAM, ROM, other persistent and auxiliary memory, and/or any non-transitory computer-readable media.

In this illustrative example, the content catalog 152, the supplemental information catalog 154, and the braille catalog 158 can be implemented by the distributed computing environment 155. In addition, in some embodiments, the marketplace server 156 or other components of the electronic marketplace 150 may be implemented by the distributed computing environment. In some embodiments, the entirety of the electronic marketplace 150 may be implemented by the distributed computing environment 150.

The distributed computing environment 155 may include a collection of rapidly provisioned and released computing resources hosted in connection with the electronic marketplace 150 or a third party. The computing resources may include a number of computing, networking and storage devices in communication with one another. In some embodiments, the computing devices may correspond to physical computing devices. In other embodiments, the computing devices may correspond to virtual machine instances implemented by one or more physical computing devices. In still other embodiments, computing devices may correspond to both virtual computing devices and physical computing devices. One example of a distributed computing environment is given in U.S. Pat. No. 7,865,586, issued on Jan. 4, 2011 and entitled “CONFIGURING COMMUNICATIONS BETWEEN COMPUTING NODES” which is hereby incorporated by reference in its entirety. A distributed computing environment may also be referred to as a cloud computing environment.

With further reference to FIG. 2, illustrative components of the electronic marketplace 150 will now be discussed. The marketplace server 156 may enable browsing and acquisition of items of primary content and/or supplemental information relating to the same that are available from the electronic marketplace 150. Further, the marketplace server 156 may transmit items of primary content and/or supplemental information to user computing systems 100.

The content catalog 152 may include information on items of primary content available from the electronic marketplace 150, such as audio books and electronic books. The supplemental information catalog 154 may include supplemental information available from the electronic marketplace 150. Such supplemental information may include, by way of non-limiting example, supplemental information provided or generated by authors, editors, publishers, users of the electronic marketplace 150, or other third parties. The braille catalog 158 may include braille translations of items of primary content and supplemental information, when available, as well as synchronization data for synchronized presentation of a braille translation together with a corresponding item of primary content or supplemental information. Accordingly, the marketplace server 156 may obtain content information for an item of primary content offered by the electronic marketplace 150, as well as supplemental information and a braille translation offered by the electronic marketplace 150, and may make such primary content, supplemental information, and braille available to a user from a single network resource, such as a web site. A user may then acquire the item of primary content, supplemental information, and/or braille translation from the electronic marketplace 150.

Illustratively, marketplace server 156 may generate one or more user interfaces through which a user utilizing a computing system 100, or a distinct computing device, may browse items of primary content, supplemental information, and/or braille translations made available by the electronic marketplace 150, submit queries for items of primary content, supplemental information, and/or braille translations, view information and details regarding specific items of primary content, supplemental information, and/or braille translations, and acquire items of primary content, supplemental information, and/or braille translations.

After the user selects a desired item of primary content, supplemental information, and/or braille translation from the electronic marketplace 150, the marketplace server 156 may facilitate the acquisition of the item of primary content, supplemental information, and/or braille translation. In this regard, the marketplace server 156 may receive payment information from the user computing system 100 or distinct computing device. Certain embodiments of the marketplace server 156 may be configured to detect when a connected computing system 100 is braille-enabled, and may always offer braille translations, when available, to the user. Further, the marketplace server 156 may transmit the item of primary content, supplemental information, and/or braille translation to the computing system 100.

In some embodiments, the marketplace server 156 may, subsequent to acquisition of an item of primary content, inform a computing system 100 of newly available supplemental information which is associated with the item of primary content. The marketplace server 156 may, in some embodiments, inform the user of newly available braille translations of acquired items of primary content. In still more embodiments, the marketplace server 156 may enable streaming of items of primary content, supplemental information, and/or braille translations from the content catalog 152, the supplemental information catalog 154, or the braille catalog 158, to a user computing system 100.

Though described herein with reference to catalogs associated with an electronic marketplace 150, in some embodiments, user computing system 100 may obtain items of primary content, supplemental information, and/or braille translations from additional or alternative sources, such as third party content catalogs or supplemental information catalogs.

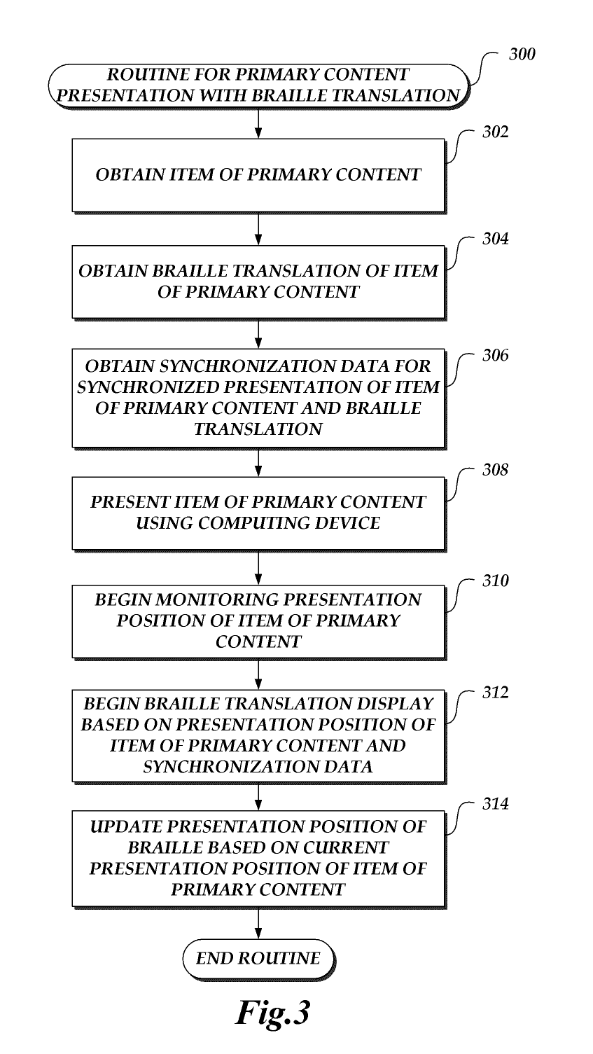

FIG. 3 is a flow diagram depicting an illustrative routine 300 for synchronous presentation of an item of primary content and a corresponding braille translation. At block 302, a computing system 100 obtains the item of primary content to be presented. The item of primary content may be obtained, for example, from a data store 114 and/or a separate computing system such as an electronic marketplace 150. The content may be stored locally on the user computing system 100 or may be streamed from electronic marketplace 150.

At block 304, the computing system 100 obtains a braille translation of the item of primary content. As discussed above, the braille translation may be generated by content conversion module 112 and stored in content data store 114. The braille translation may also be provided by the electronic marketplace 150, and may be stored in content data store 114 or streamed. In some embodiments, a partial braille translation may be available from the electronic marketplace 150, for example, a braille translation of the primary item of content, but not of supplemental information related to the item of primary content, and the content conversion module 112 may generate a braille translation for the remaining portions.

The routine 300 then moves to block 306 in which synchronization data for synchronized presentation of the item of primary content and the corresponding braille translation is obtained by the computing system 100. In embodiments in which the braille translation is provided by the electronic marketplace 150, the synchronization data may also be provided by the electronic marketplace, or may be generated by the synchronization module 116 of the computing system 100. In embodiments in which the computing system 100 generates the braille translation, the synchronization data may be generated by the synchronization module 116 during or after the translation. Synchronization data may include multiple data sets, for example a word-to-word correlation data set, a displayed portions data set correlating a portion of currently presented primary content to a portion or portions of currently presented braille translation. The word-to-word correlation data set may match a text or audio word to the corresponding braille translated word. Synchronization data may be further generated during presentation, for example the displayed portions data set may be generated as the synchronization module 116 determines a portion of the item of primary content which may be displayed at one time on the refreshable braille display 120, and then determines a next portion to be displayed, and so on. Further, the displayed portions data set may be updated during presentation if a user moves forward or backward through the item of primary content or selects a new presentation position.

Next, at block 308, the computing system 100 presents the item of primary content using the computing device 110, for example by displaying a page of text on a display screen of the computing device or by commencing output of audio content via speakers or a headphone jack. The item of primary content can be presented in any manner that the computing device 110 is capable of presenting content, such as visually, aurally, tactilely (e.g., via mechanical vibrations), or any combination of thereof. The item of primary content may be any type of content described herein, for example, an audio book. Further, the item of primary content may include only a portion of a work, for example, a chapter of an audio book.

At block 310, the computing system 100 can begin monitoring a presentation position of the item of primary content. In some embodiments this may be accomplished by the synchronization module 116. The presentation position may be a reference point or tracking point associated with the item of primary content. For example, the presentation position may represent a textual position, an audio position, and/or any other indicator of a position of the item of primary content that is being presented. In a specific example, the textual position may correspond to a page or any other unit of text within the item of primary content. In another specific example, the audio position may correspond to units of time (e.g., seconds) from a starting point in an audio file.

The presentation position of the item of primary content can be used in combination with synchronization data to determine a corresponding presentation position in the braille translation. For example, the synchronization data may be used to map a presentation position of the item of primary content to a corresponding presentation position in the braille translation. In some instances, the synchronization data can include a map of reference points in the item of primary content that correspond with reference points in the braille translation, which map can be used to determine a presentation position in the braille translation.

The braille translation can be synchronously presented with the item of primary content based on the presentation position of the item of primary content and the synchronization data at block 312. Like the item of primary content, the braille translation may include only a portion of a work, for example, a chapter of an e-book. In some instances, the braille translation can be presented using the same computing device 110 used to present the item of primary content, such as when the braille terminal 120 is integrated into the user computing device 110, or when a braille terminal 120 is equipped with speakers 144 for presentation of corresponding audio content. In other instances, the braille translation is presented using a separate braille terminal 120 with refreshable braille display in communication with the computing device 110 that presents the item of primary content.

At block 314, the presentation position of the braille translation can be updated based at least in part on a presentation position of the corresponding item of primary content. For example, as the presentation position of the item of primary content changes, the synchronization module 116 of the computing device 110 can determine a corresponding presentation position for the braille translation using the synchronization data. Based on this determination, the presentation position of the braille translation can be synchronized with the presentation position of the item of primary content. In a specific example, this may include refreshing the braille text 148 displayed on the refreshable braille display 146 of the braille terminal 120 when the presentation of item of primary content has advanced beyond the braille text 148 currently being displayed. In some embodiments, for example, when the refreshable braille display 146 employs a rotatable braille display panel, the presentation position of the braille can be continually updated based on the presentation position of the item of primary content to enable an enhanced user experience of synchronously consuming the item of primary content and the braille translation.

FIG. 4 is a flow diagram depicting an illustrative routine 400 for presentation of supplemental information. The routine 400 may illustratively be implemented by the supplemental synchronization module 116 of the computing device 110. The routine 400 begins at block 402, which causes the presentation of an item of primary content, such as an audio book. Presentation may begin, for example, in response to a user command.

At block 404, the computing device 110 determines whether supplemental information is associated with a current position within the item of primary content. As described above, supplemental information may be made associated with a range of positions within an item of primary content (e.g., with a continuous 10 second range). If supplemental information is not available, presentation continues at block 414, described below. If the current presentation position is within such a range, and supplemental information is therefore available, the routine 400 proceeds to block 406, in which an indication that supplemental information is available, is issued via an alert portion 149 of the braille terminal 120. As described above, this indication may correspond to audio output by the alert portion 149, such as a tone, bell, voice, or sound, or to haptic feedback, such as a vibration of the alert portion 149.

At block 408, the computing device 110 tests whether the user has entered a command to present the detected supplemental information. As described above, such a command may correspond to input via an input control, such as one of the plurality of buttons 142 on braille terminal 120, and may be communicated with the user computing device 110 via the input module 122. In some embodiments, the command may correspond to a voice command from the user. If a command is not received, presentation continues at block 414, described below. If a command is received, the routine 400 continues to block 410, which causes the presentation of the supplemental information (and temporarily pauses or interrupts presentation of the item of primary content and corresponding braille translation). Presentation of the supplemental information may include, in an example, supplemental audio information synchronously presented with a corresponding braille translation of the supplemental audio information. In another example, the supplemental information may be presented only aurally or only in braille. In yet another example, presentation of the item of primary content may continue while supplemental information is presented in braille. This may be useful, for instance, to convey a braille description of visual information from item of primary content during presentation of the same, such as a braille description of an image accompanying the original text from which the audio book was narrated. The refreshable braille display 146 of the braille terminal 120 may also be configured to present a tactile representation of such visual information, such as by illustrating a building layout or landscape, or by presenting and updating the locations of characters in a current scene relative to one another.

After presentation of the supplemental information is completed, presentation of the item of primary content and optionally the corresponding braille translation resumes at block 414. Alternatively, the routine 400 may also be configured to receive a user command at block 410 to cease the presentation of the supplemental information and immediately resume presentation of the item of primary content.

Additionally, as described above, some supplemental information may itself be associated with supplemental information. In these embodiments, additional instances of routine 400 may be executed at block 410, such that the user may indicate that secondary supplemental information should be presented. As will be appreciated by one skilled in the art, each additional instance of block 410 may create an instance of routine 400, such that presentation any configuration of supplemental information may be facilitated.

At block 414, presentation of the item of primary content resumes. Synchronized presentation may be resumed together with the corresponding braille translation of the item of primary content. As discussed above, synchronized presentation may be resumed at or near the point at which it was ceased. For example, presentation may be resumed at a point prior to where presentation was ceased, such as the beginning of a previous paragraph. At block 416, the routine 400 tests whether to end presentation of the item of primary content. Presentation may be ended, for example, in response to a user command or completion of the item of primary content. If presentation is not ended, the routine continues at block 404, as described above. If presentation is ended, the routine 400 may end.

In some embodiments, the user computing system 100 may not stop presentation of the item of primary content when, at block 408, the user indicates that supplemental information should be presented. The routine 400 or a variation thereof may be available for a mode of coordinated presentation of the item of primary content and any available haptic supplemental information, such as braille supplemental information or tactile representations of accompanying visual information as described above. For example, a study guide of an audio book may be presented to a user in braille during presentation of the audio book. As another example, during presentation of an audio book, a user may be presented with braille character summaries of the characters present in a current scene of the audio book. In addition, a braille display having a dynamically shapeable surface may be able to render basic or complex three-dimensional representations of objects. For instance, the surface may be configured as an outline of a landscape, and a user may elect to be presented with such a tactile representation of the landscape in which a current audio book scene takes place. The dynamically shapeable surface may also be able to render three-dimensional representations or approximations of two-dimensional illustrations accompanying the text to which an audio book corresponds so that a visually impaired user may sense the illustrations through their fingertips. Other tactile information may be presented via a dynamically shapeable surface.

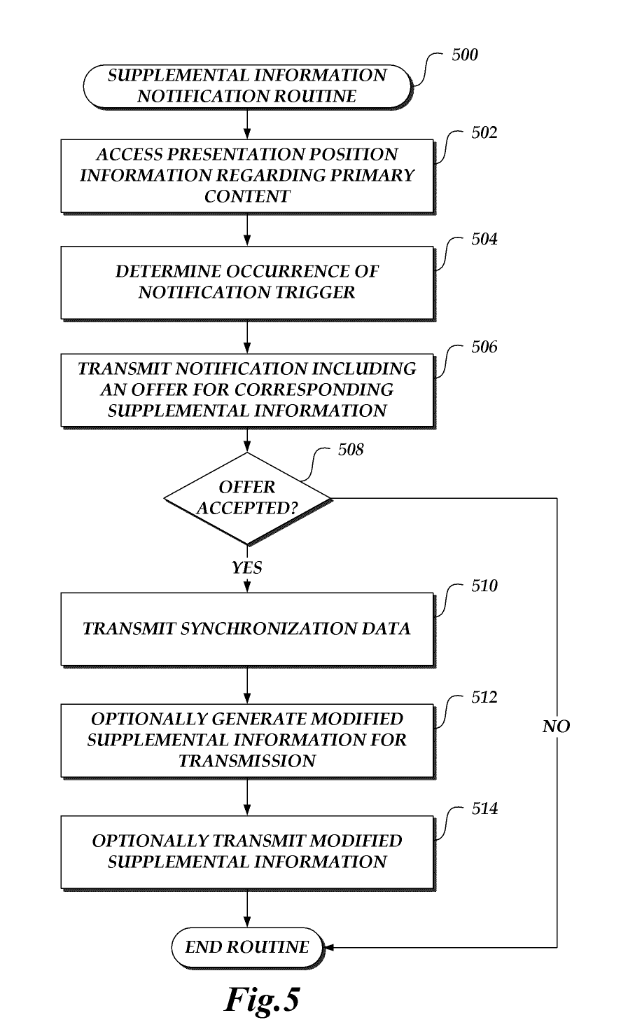

With reference to FIG. 5, a flow diagram depicting an illustrative routine 500 for notifying a computing device or system, such as a computing system 100 of FIG. 1A, of the availability of supplemental information will be described. This routine 500 may be useful where a user acquires an item of primary content for which supplemental information and/or a braille translation later becomes available. For example, in some embodiments, the routine 500 may be implemented by synchronization module 116. In other embodiments, the routine 500 may be implemented in part or in its entirety by the computing system 100, itself, or by the electronic marketplace 150 of FIG. 2.

The routine 500 may begin at block 502, where the synchronization module 116 may access presentation position information of an item of primary content (e.g., an e-book or audio book). Thereafter, at block 504, the synchronization module 116 may determine the occurrence of a notification trigger. A notification trigger may be determined, as described above, from a page number of a presented e-book text or a presentation time of an audio book. For example, a notification trigger indicating that a braille translation is now available for the item of primary content may be provided at the beginning of presenting the item of primary content. A notification trigger for newly available supplemental information may be presented at the relevant time during presentation of the item of content. The notification trigger may also be determined from a plurality of other data, such as a recently spoken or currently displayed character or place name, availability of an illustration in an e-book or an e-book corresponding to an audio book, etc. In other embodiments, the computing system 100 and/or electronic marketplace 150 may be configured to determine occurrences of notification triggers, and to transmit an indication of such a trigger to the synchronization module 116. As such, the determination of a notification trigger may correspond to receiving an indication from the computing system 100 that a notification trigger has occurred.

In response to a determination of a notification trigger, the electronic marketplace 150 may, at block 506, transmit a notification to the computing system 100 corresponding to an offer to acquire a corresponding supplemental information, such as supplemental information about the item of primary content or a braille translation of the item of primary content. In some embodiments, block 506 may include determining the availability of supplemental information. Illustratively, the transmitted notification may enable a user to accept or decline the offer to acquire the supplemental information, for example through a user interface prompted by the transmitted notification.

In some embodiments, offers may be associated with various acquisition conditions for acquiring all or a portion of the supplemental information. For example, in some embodiments, a portion the supplemental information may be offered for trial use, subject to usage restrictions. Usage restrictions may correspond, for example, to a limited time of use (e.g., use over only a given time frame, or use for a given period). One skilled in the art will recognize that various additional usage restrictions may exist. For example, use of the supplemental information may be limited to a single “session” (e.g., a continuous period of use). As a further example, use of the supplemental information may be limited to a single device, a single location, etc.

In other embodiments, all or a portion of the supplemental information may be provided for a purchase amount. For example, in some embodiments, the supplemental information may be offered, via a notification, for the same price that it would otherwise be offered for separately. In other embodiments, the supplemental information may be offered for a different (e.g., lower) fee than would otherwise be associated with acquisition of the supplemental information, or for free. For example, a user that has previously purchased the Wuthering Heights audio book may be enabled to purchase a corresponding braille translation at a lower price than would normally be required for purchasing the braille translation. Accordingly, the combined cost of acquiring or otherwise accessing both a primary item of content and supplemental information may be lower than the cost of separately acquiring both the item of primary content and the supplemental information. One skilled in the art will appreciate that any number of fees or licenses may be associated with acquisition of supplemental information. As such, any fee or license, or combination thereof, may be associated with a transmitted notification.

After transmission of a notification including an offer to a user, a determination may be made as to whether a user has accepted the offer associated with the notification. If the user declines the offer, the routine 500 may terminate. However, if the user accepts the offer, the routine 500 may continue at block 500. Specifically, at block 510, synchronization data corresponding to the supplemental information may be transmitted to the computing device 110. Synchronization information may have been determined, for example, by the electronic marketplace 150 of FIG. 2, as described in more detail above. Illustratively, the synchronization information may enable to the computing system 100 to synchronously present a braille translation with the corresponding item of primary content, or may enable presentation of supplemental information at relevant positions in the item of primary content.

Optionally, at blocks 512 and 514, a modified portion of the supplemental information may be generated and transmitted to the computing system 100. For example, the previously transmitted notification may correspond to an offer to acquire a limited portion of the supplemental information (e.g., for trial use) subject to usage restrictions. As such, at block 512, the electronic marketplace 150 may generate modified supplemental information including the limited portion. Further, in some embodiments, the electronic marketplace 150 may modify the supplemental information in order to enforce usage restrictions (e.g., a limited duration of presentation). In other embodiments, usage restrictions may be enforced through other mechanisms, such as through other functions on the computing system 100. At block 514, the modified supplemental information may be transmitted to the computing system 100, therefore enabling the computing system 100 to synchronously present the item of primary content and the modified supplemental information.

In some embodiments, the computing system 100 may be configured to stream all or a part of the supplemental information (e.g., from the electronic marketplace 150). As such, in these embodiments, either or both of blocks 512 and 514 may be non-essential, and thus omitted. For example, the electronic marketplace 150 may enable the computing system 100 to stream only a trial portion of the supplemental information, therefore negating the requirement that the supplemental information be modified. In still other embodiments, the computing system 100 may be configured to both stream the supplemental information and to download the supplemental information. For example, the computing system 100 may initially stream the supplemental information (e.g., in order to facilitate immediate presentation), while downloading the supplemental information for non-streaming presentation at a later time. Accordingly, after receiving the supplemental information, as well as synchronization data regarding the item of primary content and the supplemental information, the computing system 100 may enable synchronous presentation the item of primary content and a braille translation, or alternately enable presentation of the item of primary content and supplemental information.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by one or more general purpose computers or processors, thus transforming the general purpose computers or processors into specifically configured devices. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A non-transitory computer-readable storage medium storing instructions which, when executed, cause a processor to at least:
access an audio book;
access supplemental information related to the audio book;
cause presentation of the audio book on an output device;
determine that the supplemental information is associated with a current presentation position within the audio book;
generate an indication that the supplemental information is available for presentation;
receive input from an input device indicating that the supplemental information should be presented; and
in response to the input, cause presentation of the supplemental information item on a braille display.

2. The non-transitory computer-readable storage medium of claim 1, wherein the supplemental information comprises at least one of braille, a tactile representation of an object, or a tactile representation of an image.

3. The non-transitory computer-readable storage medium of claim 1, wherein the supplemental information comprises at least one of at least one of a character description, place description, imagery description, footnote, editor commentary, author commentary, user commentary, endnote, glossary information, study guide, or an appendix.

4. A system comprising:
a data store configured to store an item of primary content and supplemental information related to the item of primary content; and
a computing device in communication with the data store, the computing device configured to at least:
cause presentation of the item of primary content via an output device;
determine that supplemental information related to the item of primary content is associated with a current presentation position within the item of primary content;
cause generation of an indication that supplemental information related to the item of primary content is available for presentation;
receive input indicating that the supplemental information item should be presented; and
cause presentation of the supplemental information on a braille display.

5. The system of claim 4, wherein the computing device is further configured to cause presentation of the item of primary content via the output device to pause during presentation of the supplemental information item on the braille display, and to cause output of the audio book via the output device to resume after presentation of the supplemental information on the braille display.

6. The system of claim 4, wherein the computing device is further configured to at least cause presentation of the item of primary content on the output device to continue during presentation of the supplemental information on the braille display.

7. The system of claim 4, wherein the computing device is further configured to at least cause presentation of the supplemental information via the output device.

8. The system of claim 7, wherein the computing device is further configured to at least cause presentation of the supplemental information via the output device synchronously with presentation of the supplemental information on the braille display.

9. The system of claim 4, wherein the output device comprises at least one of a media player device, a desktop computer, a laptop computer, a tablet computer, an electronic book reader, a gaming console, or a mobile phone.

10. The system of claim 4, wherein the supplemental information comprises at least one of a character description, place description, imagery description, footnote, editor commentary, author commentary, user commentary, endnote, glossary information, study guide, or an appendix.

11. The system of claim 4, wherein the item of primary content comprises at least one of an electronic book, an audio book, or a braille book.

12. The system of claim 4, wherein the braille display comprises a touchscreen with haptic feedback.

13. The system of claim 4, wherein the braille display comprises an electro-mechanical device comprising a plurality of pins configured to be raised or depressed to form at least one braille symbol.

14. The system of claim 4, wherein the braille display comprises a dynamically shapeable surface configured to present at least one of braille, tactile representations of objects, or tactile representations of images.

15. The system of claim 4, wherein the generated indication is at least one of a sound, a visual indication, or a vibration.

16. A computer-implemented method comprising:
under control of a computing device configured with specific, computer-executable instructions,
causing output of an item of primary content via an output device;
determining that supplemental information related to the item of primary content is associated with a current presentation position within the item of primary content being output via the output device;
receiving input via an input device indicating that the supplemental information should be presented; and
causing output of the supplemental information via a haptic display device.

17. The computer-implemented method of claim 16, wherein the supplemental information comprises at least one of braille text, a tactile representation of an object, or a tactile representation of an image.

18. The computer-implemented method of claim 16, wherein the item of primary content comprises at least one of an electronic book, audio book, or a braille book.

19. The computer-implemented method of claim 16, further comprising receiving the supplemental information from another computing device via a network.

20. The computer-implemented method of claim 16, wherein the input is received via the input device in response to an indication that the supplemental information is available for presentation.

21. The computer-implemented method of claim 16, further comprising causing output of the item of primary content via the output device to pause in response to receiving the input and causing output of the item of primary content via the output device to resume after output of the supplemental information on the haptic display device is concluded.

22. The computer-implemented method of claim 21, wherein causing output of the item of primary content to resume comprises causing output of the item of primary content via the output device to resume prior to a point at which the output of the item of primary content via the output device was paused.

23. The computer-implemented method of claim 16, further causing output of the item of primary content via the output device to continue together with output of the supplemental information on the haptic display device, in response to obtaining the input.

24. The computer-implemented method of claim 16, wherein the supplemental information comprises primary supplemental information, wherein the primary supplemental information is associated with secondary supplemental information, and wherein the computer-implemented method further comprises:
determining that secondary supplemental information is associated with a current presentation position within the primary supplemental information;
causing generation of an indication that secondary supplemental information is available for presentation;
receiving input indicating that the secondary supplemental information should be presented; and
causing output of the secondary supplemental information on the haptic display device.
